(19) United States
(12) Patent Application Publication
(10) Pub. No.: US 2023/0341623 A1
(43) Pub. Date: Oct. 26, 2023

(54) PLASMONIC JUNCTION ON A PACKAGE FOR ENHANCING EVANESCENT COUPLING OF OPTICAL INTERCONNECTS

(71) Applicant: Intel Corporation, Santa Clara, CA (US)

(72) Inventor: Brandon C. MARIN, Gilbert, AZ (US)

(21) Appl. No.: 17/729,974

(22) Filed: Apr. 26, 2022

(51) Int. Cl. G02B 6/12; G02B 6/122

(52) U.S. Cl. CPC G02B 6/1225; G02B 6/12002; G02B 2006/12121; G02B 2006/1213

(57) ABSTRACT

Embodiments disclosed herein include optical interconnects and methods of forming such optical interconnects. In an embodiment, the optical interconnect comprises a package substrate, where an optical waveguide is embedded in the package substrate. In an embodiment, a photonics integrated circuit (PIC) is over the package substrate, where the PIC comprises a laser that is configured to be optically coupled to the optical waveguide. In an embodiment, the optical interconnect further comprises a plasmonic junction between the laser and the optical waveguide.

### TECHNICAL FIELD

Embodiments of the present disclosure relate to electronic packages, and more particularly to evanescent coupling of optical interconnects with a plasmonic junction.

### BACKGROUND

Photonics integrated circuits (PICs) include one or more lasers that are used to propagate signals using optical communication architectures. The lasers are optically coupled to a waveguide embedded in an underlying package substrate, such as a glass substrate. The laser may be optically coupled to the waveguide using various architectures. Some coupling architecture include expanded beam coupling, direct coupling, and evanescent coupling.

A major integration challenge is finding a solution that improves alignment tolerances. Tolerances in the X-Y direction and the Z-direction are all critical to providing excellent signal coupling to the waveguide. Each of the coupling architectures above have strengths and weaknesses when it comes to coupling efficiency. However, none of the architectures provide excellent tolerance in each of the coupling planes. Coupling is further hindered by warpage of the package substrate or other material variations in the optical package.

### BRIEF DESCRIPTION OF THE DRAWINGS

FIG. 1A is a cross-sectional illustration of an evanescent coupling architecture, in accordance with an embodiment.

FIG. 1B is a cross-sectional illustration of an evanescent coupling architecture that includes a plasmonic junction, in accordance with an embodiment.

FIG. 1C is a graph showing the Z-tolerance of the evanescent coupling architectures in FIG. 1A and FIG. 1B, in accordance with an embodiment.

FIG. 2A is a cross-sectional illustration of an evanescent coupling architecture with a plasmonic junction that includes a base and nano-features over the base, in accordance with an embodiment.

FIG. 2B is a cross-sectional illustration of one of the nano-features that illustrates the focusing of the optical signal, in accordance with an embodiment.

FIG. 3A is a perspective view illustration of a package substrate with a plasmonic junction over the package substrate, in accordance with an embodiment.

FIG. 3B is a graph of the resonant wavelength and the corresponding d-spacing between the nano-features, in accordance with an embodiment.

FIG. 4A is a cross-sectional illustration of a package substrate, in accordance with an embodiment.

FIG. 4B is a cross-sectional illustration of the package substrate after an optical waveguide is formed with a laser, in accordance with an embodiment.

FIG. 4C is a cross-sectional illustration of the package substrate after a plasmonic junction with a backing layer is disposed over the optical waveguide, in accordance with an embodiment.

FIG. 4D is a cross-sectional illustration of the package substrate after the backing layer is removed, in accordance with an embodiment.

FIG. 4E is a cross-sectional illustration of the package substrate after a photonics integrated circuit (PIC) is placed above the package substrate so that a laser is optically coupled to the optical waveguide through the plasmonic junction, in accordance with an embodiment.

FIG. 5A is a perspective view illustration of an electronic package with a plasmonic junction that includes cylinder nano-features, in accordance with an embodiment.

FIG. 5B is a perspective view illustration of an electronic package with a plasmonic junction that includes pyramid nano-features, in accordance with an embodiment.

FIG. 5C is a cross-sectional illustration of a plasmonic junction that includes spherical nano-features, in accordance with an embodiment.

FIG. 5D is a cross-sectional illustration of a plasmonic junction that includes plate nano-features, in accordance with an embodiment.

FIG. 6 is a cross-sectional illustration of an electronic system with a PIC that is optically coupled to a waveguide through a plasmonic junction, in accordance with an embodiment.

FIG. 7 is a schematic of a computing device built in accordance with an embodiment.

### EMBODIMENTS OF THE PRESENT DISCLOSURE

Described herein are architectures with evanescent coupling of optical interconnects with a plasmonic junction, in accordance with various embodiments. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

As noted above, multiple different optical interconnect architectures can be used to optically couple a photonics integrated circuit (PIC) to an optical waveguide in the package substrate. In a particular example, evanescent coupling can be used. Evanescent coupling generally has good X-direction tolerance (e.g., 1,000 µm) and mediocre Y-direction tolerance (e.g., 2 µm). However, the Z-direction tolerance of evanescent coupling is severely limited. Typically, the Z-direction tolerance is less than 1.5 µm. Accordingly, embodiments disclosed herein include architectures that significantly improve the Z-direction coupling tolerance. The embodiments disclosed herein also improve the X-direction and Y-direction tolerances. The improvement of the alignment tolerances enables improved coupling efficiency that can improve device yield.

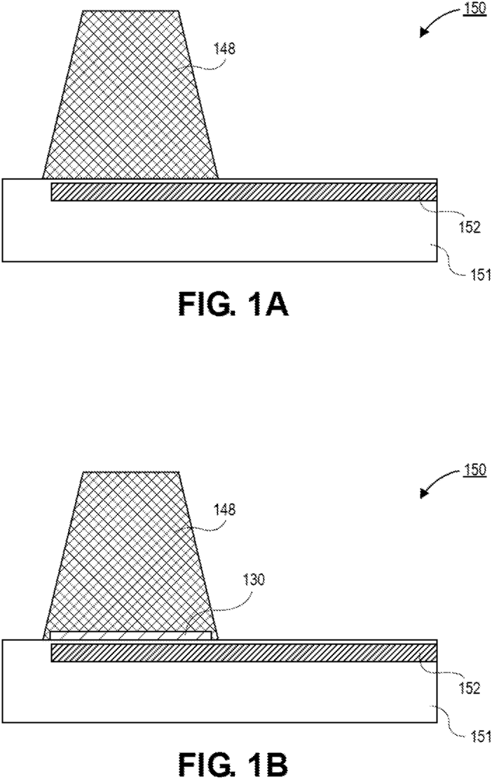

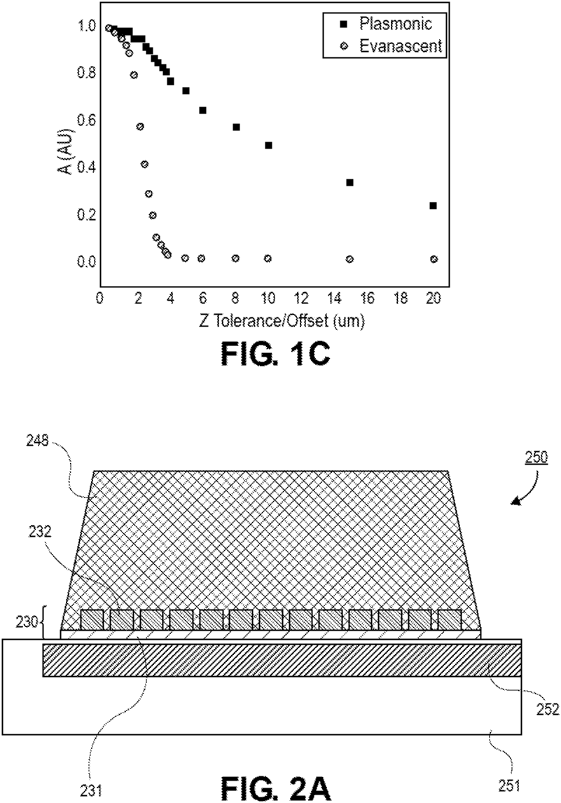

An example of evanescent coupling in a package 150 is shown in FIG. 1A. As shown, electromagnetic radiation 148 (e.g., from a laser (not shown)) is used to expose an end of the optical waveguide 152 in a package substrate 151. As shown in the graph of FIG. 1C, the Z-tolerance quickly drops off and there is poor coupling at Z-distances greater than approximately 3 µm.

In order to improve the Z-tolerance (and tolerances in other directions), a plasmonic junction is placed over the optical waveguide. The plasmonic junction is used to focus the electromagnetic radiation in order to improve optical coupling. For example, nano-features of the plasmonic junction can serve as antennas to magnify the electromagnetic radiation (e.g., 25X or greater). Generally, plasmonic junctions utilize plasmons to improve optical coupling. Plasmons are the collection of oscillations of conduction electrons. Inherently, plasmons can couple with electric fields, like light, and enhance the localization and hence absorption of light into the optical waveguide.

An example of a package 150 that includes a plasmonic junction 130 is shown in FIG. 1B. As shown, the plasmonic junction 130 is placed over the waveguide 152. The plasmonic junction 130 in FIG. 1B is shown as a simple rectangle for simplicity. It is to be appreciated that the plasmonic junction 130 may include nano-features, as will be described in greater detail below. Generally, the plasmonic junction 130 serves to amplify the electromagnetic radiation 148 that reaches the waveguide 152. As shown in FIG. 1C, the Z-tolerance is significantly improved and provides acceptable signal strength at a Z-displacement of up to approximately 8 µm. In addition to the improvement in the Z-tolerance, Y-tolerance can also be improved (e.g., up to approximately 10 µm), and the X-tolerance can be improved (e.g., to up to approximately 1,500 µm).

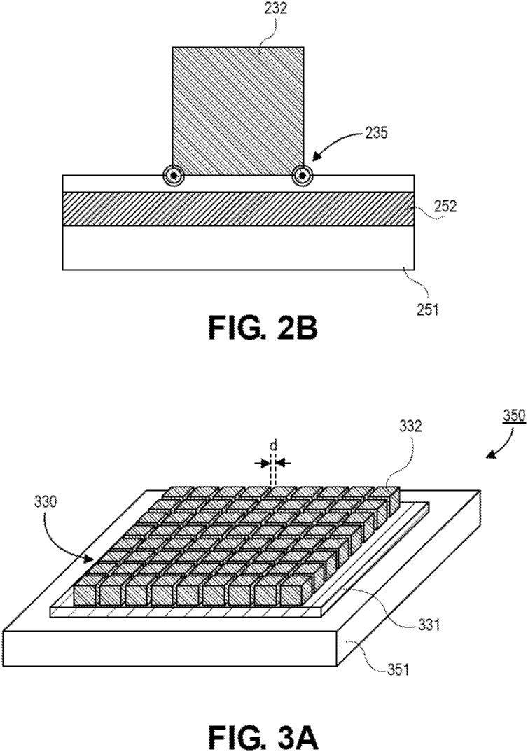

Referring now to FIG. 2A, a cross-sectional illustration of a package 250 with a plasmonic junction 230 is shown, in accordance with an embodiment. In an embodiment, the package 250 may comprise a package substrate 251. The package substrate 251 may include a glass substrate. Though, in other embodiments an organic package substrate may be used instead of glass. In an embodiment, a waveguide 252 may be embedded in the package substrate 251. The waveguide 252 may be formed with a laser process, as will be described in greater detail below. In an embodiment, the waveguide 252 may be recessed below a top surface of the package substrate 251. That is, the waveguide 252 may be entirely embedded in the package substrate 251 in some embodiments.

In an embodiment, a plasmonic junction 230 may be provided over an end of the waveguide 252. The plasmonic junction 230 may comprise a base 231 and nano-features 232 over the base 231. The nano-features 232 may be coupled to the base 231 through electrostatic coupling or any other adhesion regime. In an embodiment, the base 231 may be a material that is optically transparent to the wavelength of the electromagnetic radiation 248. In a particular embodiment, the base 231 may comprise graphene. In an embodiment, the plasmonic junction 230 may have X and Y dimensions that are between approximately 2 mm and approximately 10 mm. As used herein “approximately” refers to a value that is within 10% of the stated value. For example, approximately 10 mm may refer to a range between 9.0 mm and 11 mm. In an embodiment, a Z-height of the nano-features 232 may be between approximately 50 nm and approximately 100 nm.

In an embodiment, the nano-features 232 may have dimensions that is approximately 100 nm or smaller, or approximately 50 nm or smaller. In the illustrated embodiment, the nano-features 232 are shown as cubes. However, it is to be appreciated that other nano-feature 232 architectures may be used, as will be described in greater detail below. In an embodiment, the nano-features 232 may comprise a conductive material. In a particular embodiment, the nano-features 232 comprise noble metal nanoparticles. For example, the nano-features 232 may comprise silver, gold, platinum, copper, or palladium. In an embodiment, the nano-features 232 may also be coated with a passivation ligand. For example, passivation ligands may include polyvinylpyrrolidone (PVP), carboxylates, or a thiolate. Passivation of the nano-features 232 may help prevent oxidation of the nano-features 232 that would otherwise degrade the optical properties of the plasmonic junction 230.

In an embodiment, the plasmonic junction 230 may be formed with any suitable manufacturing process. In one embodiment, the nano-features 232 are adhered to the base 231 using a Langmuir-Blodgett film technique with colloidal nanoparticles. In other embodiments, the nano-features 232 may be fabricated with a lithography process. In such an embodiment, a layer of noble metal may be provided over a substrate, such as base 231, and patterned through with an etching process in order to form discrete nano-features.

In an embodiment, the electromagnetic radiation 248 may be provided from a PIC (not shown) that is provided over the plasmonic junction 230. The electromagnetic radiation 248 may be provided from a laser that is integrated with the PIC. In an embodiment, the electromagnetic radiation may be near infrared (NIR) radiation. For example, the wavelength may be between approximately 850 nm and approximately 1,550 nm.

Referring now to FIG. 2B, a zoomed in cross-sectional illustration showing a single one of the nano-features 232 is shown, in accordance with an embodiment. In an embodiment, electromagnetic radiation (not shown) is propagated from above the nano-feature 232 to the waveguide 252. As shown, the nano-feature 232 amplifies the intensity of the signal as indicated at the corners 235 of the nano-feature 232. The amplification of the signal may be approximately 25X or greater. In some embodiments the amplification may be up to approximately 80X. By amplifying the signal, Z-direction tolerance is improved. That is, any change in the Z-offset of the laser (not shown) relative to the waveguide 252 may reduce the intensity of the light, but since the light is significantly magnified in intensity, there is still sufficient signal intensity to properly couple with the waveguide 252. In the illustrated embodiment, the nano-feature 232 is shown as having a cube shape. A cube shape may be optimal, due to the sharp corners 235 where the amplification can occur. However, in other embodiments, signal amplification may also be provided with other nano-feature 232 shapes, such as cylinders, pyramids, plates, and spheres.

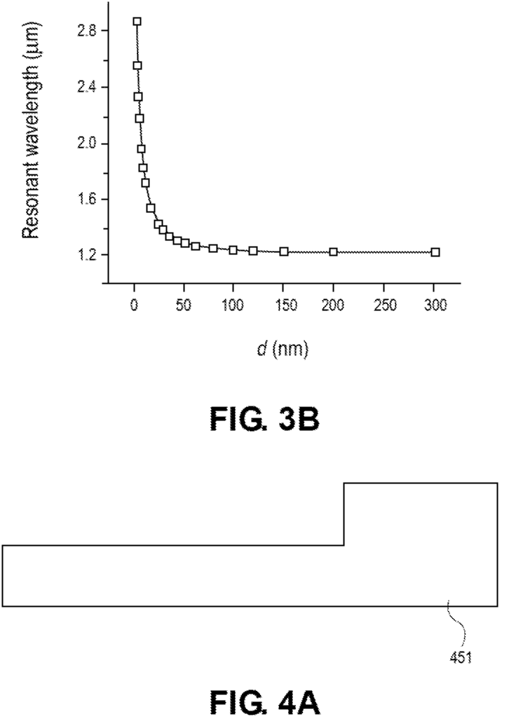

Referring now to FIG. 3A, a perspective view illustration of a portion of a package 350 is shown, in accordance with an embodiment. In an embodiment, the package 350 may comprise a package substrate 351. The package substrate 351 may comprise glass in some embodiments. In an embodiment, a waveguide (not shown) is embedded in the package substrate 351. The waveguide may be provided below a top surface of the package substrate.

In an embodiment, a plasmonic junction 330 may be provided over a top surface of the package substrate 351. The plasmonic junction 330 may include a base 331. The base 331 may be a material that is substantially transparent to the electromagnetic radiation used in the signal that is propagated to the waveguide in the package substrate 351. For example, the base 331 may comprise graphene. The base 331 may have a thickness that is approximately 10 nm or less, or approximately 5 nm or less.

In an embodiment, the plasmonic junction 330 may further comprise an array of nano-features 332. The nano-features 332 shown in FIG. 3A may be cubes. Though, it is to be appreciated that other shapes may also be used, as will be described in greater detail below. In an embodiment, the nano-features 332 may comprise a noble metal. For example, the nano-features 332 may be silver nano-cubes in some embodiments. Though, other metals may also be used. In the illustrated embodiment, the size of the nano-features 332 is not to scale. While 72 nano-features 332 are shown in FIG. 3A, it is to be appreciated that hundreds or more or thousands or more nano-features 332 may be provided over the base 331. The base 331 may have edges that are between approximately 2 mm in length and approximately 10 mm in length.

In an embodiment, the spacing d between the nano-features 332 may be chosen in order to tune the resonance of the amplified electromagnetic radiation. As shown in the graph in FIG. 3B, values of d that are greater than approximately 15 nm result in strong coupling in the wavelengths between approximately 850 nm and approximately 1,550 nm which are typical of optical communication frequencies. Increasing the distance d also improves the manufacturability of the plasmonic junction 330. That is, it is easier to attach or pattern the nano-features 332 when the spacing d is increased. In a particular embodiment, the spacing d may be between approximately 15 nm and approximately 300 nm.

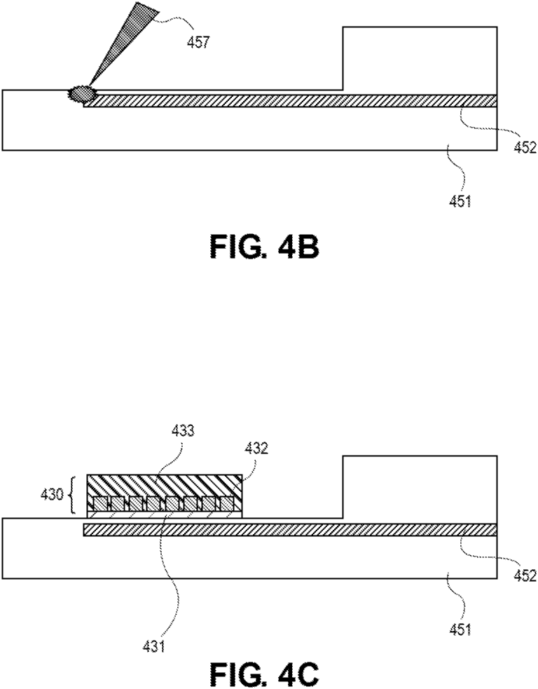

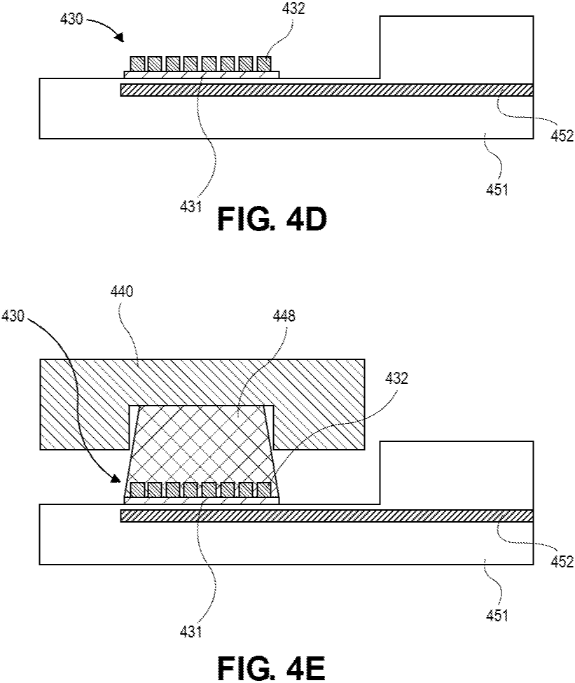

Referring now to FIGS. 4A-4E, a series of cross-sectional illustrations depicting a process for fabricating a package with a plasmonic junction to improve evanescent coupling is shown, in accordance with an embodiment. As will be shown, the transfer of the plasmonic junction can be implemented with a pick-and-place tool. That is, the individual nano-features do not need to be handled. As such, manufacturability of the package is improved.

Referring now to FIG. 4A, a cross-sectional illustration of a package substrate 451 is shown, in accordance with an embodiment. In an embodiment, the package substrate 451 may be a glass substrate. However, in other embodiments, an organic package substrate may also be used. When an organic package substrate is used, the process to embed the waveguide in the package substrate 451 may be different than what is shown in FIGS. 4A-4E. Other than having a different type of waveguide integration, the processing may be substantially similar to what is shown in FIGS. 4A-4E.

In an embodiment, a cavity may be provided in the package substrate 451. The cavity may be positioned in a location in order to accommodate a PIC that will be added in a subsequent processing operation. However, in other embodiments, the package substrate 451 may not need a cavity, trench, or the like.

Referring now to FIG. 4B, a cross-sectional illustration of the package substrate 451 after a waveguide 452 is formed in the package substrate 451 is shown, in accordance with an embodiment. In an embodiment, the waveguide 452 may be formed by exposure by a laser 457. The laser 457 may scan across the surface of the package substrate 451 in order to form the waveguide 452 with a desired length. The waveguide 452 may extend to an edge of the package substrate 451 and extend under the cavity. In an embodiment, the laser 457 alters the structure of the package substrate 451 in order to change the index of refraction. That is, the waveguide 452 and the package substrate 451 may have different indexes of refraction in order to allow for total internal reflection (TIR) of electromagnetic radiation that is coupled into the waveguide 452 with the evanescent coupling. In an embodiment, the waveguide 452 may be entirely embedded in the package substrate 451. For example, portions of the package substrate 451 surround an entire perimeter of the waveguide 452.

Referring now to FIG. 4C, a cross-sectional illustration of the package substrate 451 after a plasmonic junction 430 is placed on a surface of the package substrate 451 is shown, in accordance with an embodiment. In an embodiment, the plasmonic junction 430 may be provided above an end of the waveguide 452. In an embodiment, the plasmonic junction 430 may be placed in the cavity formed into the package substrate 451. The thickness of the plasmonic junction 430 may be thinner than the depth of the cavity in some embodiments.

In an embodiment, the plasmonic junction 430 may comprise a base 431. The base 431 may be a material that is substantially transparent to the wavelength of the electromagnetic radiation that is to be coupled into the waveguide 452. For example, the base 431 may comprise graphene. In an embodiment, the plasmonic junction 430 may further comprise a plurality of nano-features 432 provided over the base 431. The nano-features 432 may be cubes, cylinders, pyramids, plates, or spheres. In an embodiment, the nano-features 432 may comprise silver, gold, platinum, copper, or palladium. In some embodiments, a passivating coating may be provided over the nano-features 432, as described above.

In an embodiment, the plasmonic junction 430 may also comprise a backing layer 433. The backing layer 433 may be a relatively thick layer that provides mechanical support to the plasmonic junction 430. Since the backing layer 433 provides mechanical support, the plasmonic junction 430 can be moved to the package substrate 451 with standard materials handling equipment. For example, a pick-and-place tool may be used in order to transfer the plasmonic junction 430 to the package substrate 451. In an embodiment, the backing layer 433 may comprise PMMA or the like.

Referring now to FIG. 4D, a cross-sectional illustration of the package substrate 451 after the backing layer 433 is removed is shown, in accordance with an embodiment. In an embodiment, the backing layer 433 may be dissolved. For example, acetone may be used to dissolve the PMMA backing layer 433 and expose the nano-features 432. However, other material removal processes may also be used depending on the material chosen for the backing layer 433. For example, the backing layer 433 may be dissolved with any suitable solvent, or an etching process may be used to remove the backing layer 433. After the backing layer 433 is removed, the plasmonic junction 430 is fully exposed above the package substrate 451.

Referring now to FIG. 4E, a cross-sectional illustration of the package substrate 451 after a PIC 440 is placed over the package substrate 451 is shown, in accordance with an embodiment. In an embodiment, the PIC 440 may be placed with a pick-and-place tool. The PIC 440 may include a cavity that is provided over the plasmonic junction 430. The cavity may be the location where a laser is provided. The laser may generate electromagnetic radiation 448 that is coupled into the waveguide 452 through evanescent coupling. In an embodiment, the evanescent coupling is improved through the use of the plasmonic junction 430, as described in greater detail above. Due to the presence of the plasmonic junction 430, the Z-tolerance between the laser and the waveguide 452 may be increased up to approximately 10 µm or greater. As such, there is plenty of tolerance to account for material warpage, component misplacement, and the like.

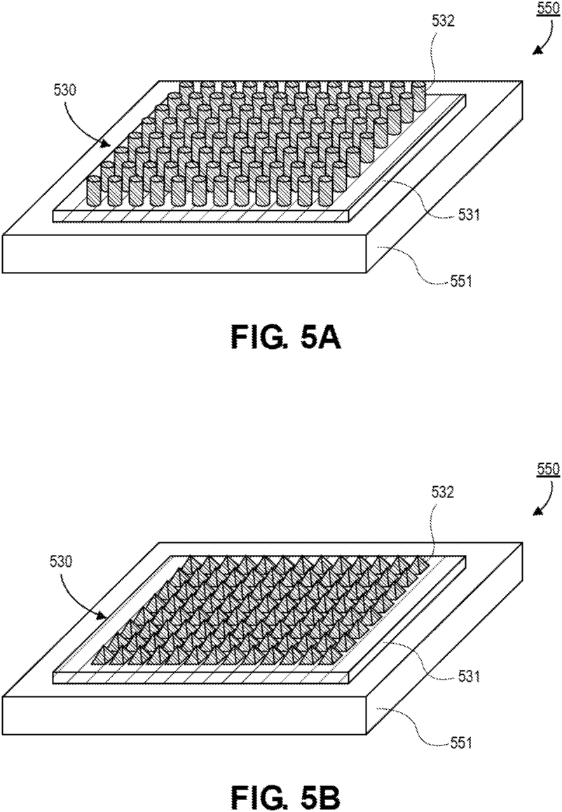

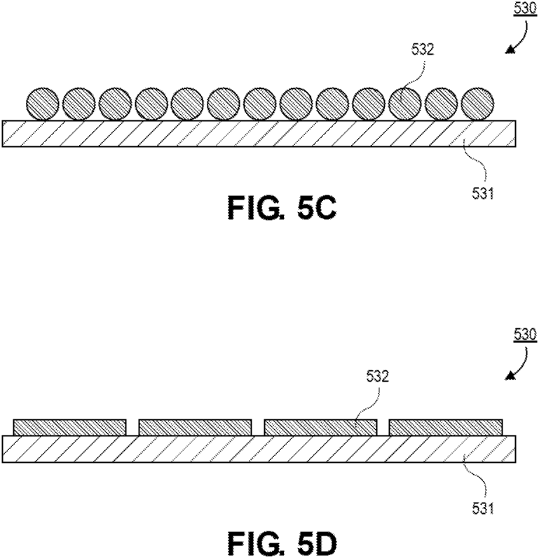

Referring now to FIGS. 5A-5D, a series of illustrations depicting plasmonic junctions 530 with various nano-feature configurations is shown, in accordance with additional embodiments. Any of the plasmonic junctions 530 in FIGS. 5A-5D may be used in a process flow similar to the flow illustrated in FIGS. 4A-4E in order to assemble an optical package.

Referring now to FIG. 5A, a perspective view illustration of a package 550 is shown, in accordance with an embodiment. In an embodiment, the package 550 may comprise a package substrate 551. The package substrate 551 may comprise glass in some embodiments. In an embodiment, a waveguide (not shown) is embedded in the package substrate 551. The waveguide may be provided below a top surface of the package substrate.

In an embodiment, a plasmonic junction 530 may be provided over a top surface of the package substrate 551. The plasmonic junction 530 may include a base 531. The base 531 may be a material that is substantially transparent to the electromagnetic radiation used in the signal that is propagated to the waveguide in the package substrate 551. For example, the base 531 may comprise graphene. The base 531 may have a thickness that is approximately 10 nm or less, or approximately 5 nm or less.

In an embodiment, the plasmonic junction 530 may further comprise an array of nano-features 532. The nano-features 532 shown in FIG. 5A may be cylinders. In an embodiment, the nano-features 532 may comprise a noble metal. For example, the nano-features 532 may be silver nano-rods in some embodiments. Though, other metals may also be used. In the illustrated embodiment, the size of the nano-features 532 is not to scale. While 96 nano-features 532 are shown in FIG. 5A, it is to be appreciated that hundreds or more or thousands or more nano-features 532 may be provided over the base 531. The base 531 may have edges that are between approximately 2 mm in length and approximately 10 mm in length.

Referring now to FIG. 5B, a perspective view illustration of a package 550 is shown, in accordance with an embodiment. In an embodiment, the package 550 may comprise a package substrate 551. The package substrate 551 may comprise glass in some embodiments. In an embodiment, a waveguide (not shown) is embedded in the package substrate 551. The waveguide may be provided below a top surface of the package substrate.

In an embodiment, a plasmonic junction 530 may be provided over a top surface of the package substrate 551. The plasmonic junction 530 may include a base 531. The base 531 may be a material that is substantially transparent to the electromagnetic radiation used in the signal that is propagated to the waveguide in the package substrate 551. For example, the base 531 may comprise graphene. The base 531 may have a thickness that is approximately 10 nm or less, or approximately 5 nm or less.

In an embodiment, the plasmonic junction 530 may further comprise an array of nano-features 532. The nano-features 532 shown in FIG. 5B may be pyramids. In an embodiment, the nano-features 532 may comprise a noble metal. For example, the nano-features 532 may be silver nano-pyramids in some embodiments. Though, other metals may also be used. In the illustrated embodiment, the size of the nano-features 532 is not to scale. While 104 nano-features 532 are shown in FIG. 5B, it is to be appreciated that hundreds or more or thousands or more nano-features 532 may be provided over the base 531. The base 531 may have edges that are between approximately 2 mm in length and approximately 10 mm in length.

Referring now to FIG. 5C, a cross-sectional illustration of a plasmonic junction 530 is shown, in accordance with an embodiment. In an embodiment, the plasmonic junction 530 may include a base 531. The base 531 may be a material that is substantially transparent to the electromagnetic radiation used in the signal that is propagated to the waveguide in the package substrate (not shown). For example, the base 531 may comprise graphene. The base 531 may have a thickness that is approximately 10 nm or less, or approximately 5 nm or less.

In an embodiment, the plasmonic junction 530 may further comprise an array of nano-features 532. The nano-features 532 shown in FIG. 5C may be spheres. In an embodiment, the nano-features 532 may comprise a noble metal. For example, the nano-features 532 may be silver nano-spheres in some embodiments. Though, other metals may also be used. In the illustrated embodiment, the size of the nano-features 532 is not to scale. While 13 nano-features 532 are shown in FIG. 5C, it is to be appreciated that hundreds or more or thousands or more nano-features 532 may be provided over the base 531. The base 531 may have edges that are between approximately 2 mm in length and approximately 10 mm in length.

Referring now to FIG. 5D, a cross-sectional illustration of a plasmonic junction 530 is shown, in accordance with an embodiment. In an embodiment, the plasmonic junction 530 may include a base 531. The base 531 may be a material that is substantially transparent to the electromagnetic radiation used in the signal that is propagated to the waveguide in the package substrate (not shown). For example, the base 531 may comprise graphene. The base 531 may have a thickness that is approximately 10 nm or less, or approximately 5 nm or less.

In an embodiment, the plasmonic junction 530 may further comprise an array of nano-features 532. The nano-features 532 shown in FIG. 5D may be plates. In an embodiment, the nano-features 532 may comprise a noble metal. For example, the nano-features 532 may be silver nano-plates in some embodiments. Though, other metals may also be used. In the illustrated embodiment, the size of the nano-features 532 is not to scale. While four nano-features 532 are shown in FIG. 5C, it is to be appreciated that hundreds or more or thousands or more nano-features 532 may be provided over the base 531. The base 531 may have edges that are between approximately 2 mm in length and approximately 10 mm in length.

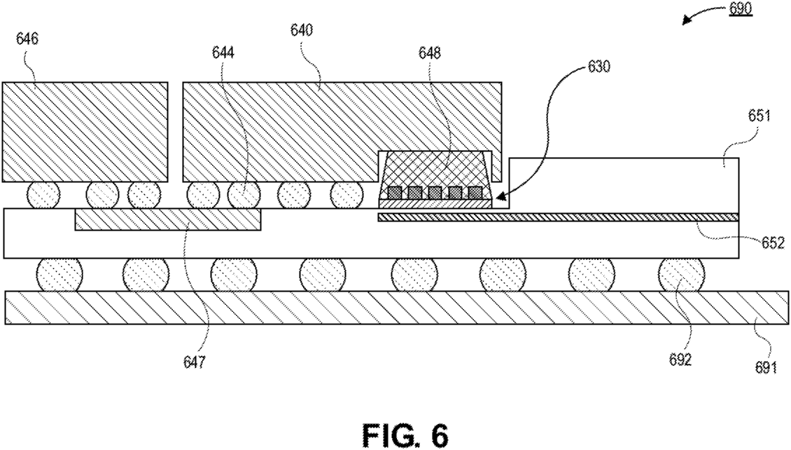

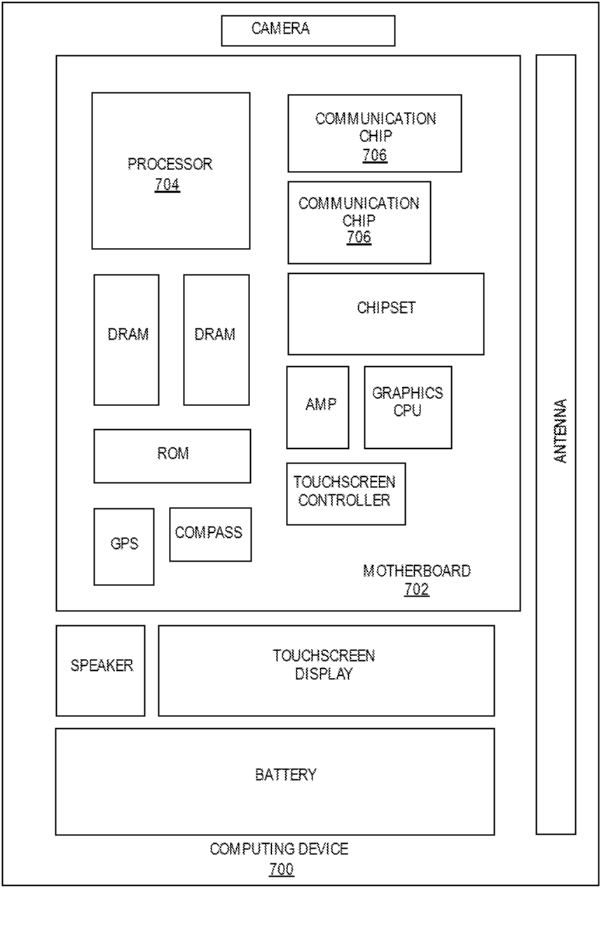

Referring now to FIG. 6, a cross-sectional illustration of an electronic system 690 is shown, in accordance with an embodiment. In an embodiment, the electronic system 690 includes an optical interconnect between a PIC 640 and a waveguide 652 in the package substrate 651. Particularly, the optical interconnect uses evanescent coupling that is aided by a plasmonic junction 630.

In an embodiment, the plasmonic junction 630 may be substantially similar to any of the plasmonic junctions described in greater detail herein. Generally, the plasmonic junction 630 may comprise a base, such as a graphene base. A plurality of nano-features may be provided over the base. For example, the nano-features may include cubes, rods, pyramids, spheres, plates, or any other shaped nano-structure. In an embodiment, the nano-features may comprise a noble metal. For example, the nano-features may be silver, gold, aluminum, platinum, copper, or palladium. The nano-features may have heights between approximately 50 nm and approximately 100 nm. A spacing between the nano-features may be approximately 15 nm or greater. In an embodiment, the plasmonic junction 630 amplifies the electromagnetic radiation 648 from the PIC 640 in order to improve allowable tolerances between the PIC laser and the waveguide 652, especially in the Z-direction. For example, the tolerance in the Z-direction between the PIC laser and the waveguide 652 may be approximately 10 µm or greater.

In an embodiment, the electronic system 690 may further comprise a board 691, such as a printed circuit board (PCB). The board 691 may be coupled to the package substrate 651 by interconnects 692. While shown as solder balls, it is to be appreciated that any interconnect architecture may be used (e.g., sockets, etc.). In an embodiment, the electronic system 690 may further comprise a die 646 that is coupled to the package substrate 651 by interconnects 644. The interconnects 644 may be solder balls or any other interconnect architecture. In an embodiment, a bridge 647 may be provided in the package substrate 651. The bridge 647 may be used to communicatively couple the PIC 640 to the die 646. The bridge 647 may have high density traces in order to provide high density coupling between the PIC 640 and the die 646. In an embodiment, the PIC 640 and the die 646 may be provided in a cavity in the package substrate 651.

FIG. 7 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others.

The processor 704 of the computing device 700 includes an integrated circuit die packaged within the processor 704. In some implementations of the invention, the integrated circuit die of the processor may be part of an electronic system that comprises an optical interconnect that includes evanescent coupling that is improved by a plasmonic junction, in accordance with embodiments described herein. The term “processor” may refer to any device or portion of a device that processes electronic data from registers and/or memory to transform that electronic data into other electronic data that may be stored in registers and/or memory.

The communication chip 706 also includes an integrated circuit die packaged within the communication chip 706. In accordance with another implementation of the invention, the integrated circuit die of the communication chip may be part of an electronic system that comprises an optical interconnect that includes evanescent coupling that is improved by a plasmonic junction, in accordance with embodiments described herein.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

Example 1: an optical interconnect, comprising: a package substrate, wherein an optical waveguide is embedded in the package substrate; a photonics integrated circuit (PIC) over the package substrate, wherein the PIC comprises a laser that is configured to be optically coupled to the optical waveguide; and a plasmonic junction between the laser and the optical waveguide.

Example 2: the optical interconnect of Example 1, wherein the plasmonic junction comprises: a base; and nano-features over the base.

Example 3: the optical interconnect of Example 2, wherein the base comprises graphene.

Example 4: the optical interconnect of Example 2 or Example 3, wherein the nano-features comprise a metal.

Example 5: the optical interconnect of Example 4, wherein the metal comprises silver, gold, aluminum, platinum, copper, or palladium.

Example 6: the optical interconnect of Example 4 or Example 5, wherein the metal is coated with a passivation ligand.

Example 7: the optical interconnect of Examples 2-6, wherein the nano-features comprise cubes.

Example 8: the optical interconnect of Examples 2-6, wherein the nano-features comprise cylinders.

Example 9: the optical interconnect of Examples 2-6, wherein the nano-features comprise pyramids.

Example 10: the optical interconnect of Examples 2-6, wherein the nano-features comprise spheres.

Example 11: the optical interconnect of Examples 2-6, wherein the nano-features comprise plates.

Example 12: the optical interconnect of Examples 2-12, wherein the nano-features are spaced at a spacing that is approximately 15 nm or greater.

Example 13: the optical interconnect of Examples 1-12, wherein the package substrate comprises glass.

Example 14: the optical interconnect of Examples 1-13, wherein the plasmonic junction has edges that are between approximately 2 mm and approximately 10 mm.

Example 15: a method of assembling an electronic package with optical interconnects, comprising: disposing a backing layer over a plasmonic junction; transferring the plasmonic junction to a package substrate, wherein the plasmonic junction is configured to be optically coupled to an optical waveguide in the package substrate; removing the backing layer; and placing a photonics integrated circuit (PIC) over the plasmonic junction, wherein the PIC comprises a laser that is configured to be optically coupled to the optical waveguide through the plasmonic junction.

Example 16: the method of Example 15, wherein the backing layer comprises PMMA.

Example 17: the method of Example 16, wherein removing the backing layer comprises dissolving the PMMA with acetone.

Example 18: the method of Examples 15-17, wherein the plasmonic junction comprises a base and nano-features over the base.

Example 19: the method of Example 18, wherein the nano-features comprise cubes, cylinders, pyramids, spheres, or plates.

Example 20: the method of Example 18 or Example 19, wherein the base comprises graphene.

Example 21: the method of Examples 18-20, wherein the nano-features have a spacing that is approximately 15 nm or greater.

Example 22: the method of Examples 15-21, wherein the package substrate comprises glass.

Example 23: the method of Examples 15-22, wherein transferring the plasmonic junction is implemented with a pick-and-place tool.

Example 24: the electronic system, comprising: a board; a package substrate with an optical waveguide coupled to the board; a photonics integrated circuit (PIC) with a laser that is configured to be optically coupled to the optical waveguide; and a plasmonic junction between the laser and the optical waveguide, wherein the plasmonic junction comprises: a base; and nano-features over the base.

Example 25: the electronic system of Example 24, wherein the nano-features have a spacing that is approximately 15 nm or greater.

What is claimed is:

1. An optical interconnect, comprising:
a package substrate, wherein an optical waveguide is embedded in the package substrate;
a photonics integrated circuit (PIC) over the package substrate, wherein the PIC comprises a laser that is configured to be optically coupled to the optical waveguide; and
a plasmonic junction between the laser and the optical waveguide.

2. The optical interconnect of claim 1, wherein the plasmonic junction comprises:
a base; and
nano-features over the base.

3. The optical interconnect of claim 2, wherein the base comprises graphene.

4. The optical interconnect of claim 2, wherein the nano-features comprise a metal.

5. The optical interconnect of claim 4, wherein the metal comprises silver, gold, aluminum, platinum, copper, or palladium.

6. The optical interconnect of claim 5, wherein the metal is coated with a passivation ligand.

7. The optical interconnect of claim 2, wherein the nano-features comprise cubes.

8. The optical interconnect of claim 2, wherein the nano-features comprise cylinders.

9. The optical interconnect of claim 2, wherein the nano-features comprise pyramids.

10. The optical interconnect of claim 2, wherein the nano-features comprise spheres.

11. The optical interconnect of claim 2, wherein the nano-features comprise plates.

12. The optical interconnect of claim 2, wherein the nano-features are spaced at a spacing that is approximately 15 nm or greater.

13. The optical interconnect of claim 1, wherein the package substrate comprises glass.

14. The optical interconnect of claim 1, wherein the plasmonic junction has edges that are between approximately 2 mm and approximately 10 mm.

15. A method of assembling an electronic package with optical interconnects, comprising:
disposing a backing layer over a plasmonic junction;
transferring the plasmonic junction to a package substrate, wherein the plasmonic junction is configured to be optically coupled to an optical waveguide in the package substrate;
removing the backing layer; and
placing a photonics integrated circuit (PIC) over the plasmonic junction, wherein the PIC comprises a laser that is configured to be optically coupled to the optical waveguide through the plasmonic junction.

16. The method of claim 15, wherein the backing layer comprises PMMA.

17. The method of claim 16, wherein removing the backing layer comprises dissolving the PMMA with acetone.

18. The method of claim 15, wherein the plasmonic junction comprises a base and nano-features over the base.

19. The method of claim 18, wherein the nano-features comprise cubes, cylinders, pyramids, spheres, or plates.

20. The method of claim 18, wherein the base comprises graphene.

21. The method of claim 18, wherein the nano-features have a spacing that is approximately 15 nm or greater.

22. The method of claim 15, wherein the package substrate comprises glass.

23. The method of claim 15, wherein transferring the plasmonic junction is implemented with a pick-and-place tool.

24. An electronic system, comprising:
a board;
a package substrate with an optical waveguide coupled to the board;
a photonics integrated circuit (PIC) with a laser that is configured to be optically coupled to the optical waveguide; and
a plasmonic junction between the laser and the optical waveguide, wherein the plasmonic junction comprises:
a base; and
nano-features over the base.

25. The electronic system of claim 24, wherein the nano-features have a spacing that is approximately 15 nm or greater.
